(19) United States
(12) Patent Application Publication
(10) Pub. No.: US 2025/0117428 A1
(43) Pub. Date: Apr. 10, 2025

(54) METHOD AND SYSTEM FOR IDENTIFYING RECURRENT CAUSAL SEQUENCES IN TEMPORAL DATASETS

(71) Applicant: National Technology & Engineering Solutions of Sandia, LLC, Albuquerque, NM (US)

(72) Inventors: Bradley Harold Theilman, Albuquerque, NM (US); James Bradley Aimone, Keller, TX (US)

(21) Appl. No.: 18/483,310

(22) Filed: Oct. 9, 2023

(51) Int. Cl. G06F 16/901

(52) U.S. Cl. CPC G06F 16/9024

(57) ABSTRACT

A computer-implemented method for identifying recurrent causal sequences in datasets is provided. The method comprises receiving at least first and second datasets each comprising a plurality of data points and computing a degree of causal relatedness for all pairs of the data points of the first and second datasets. The method comprises constructing first and second directed acyclic graphs on top of the respective first and second datasets. The method comprises constructing a second order graph using the first and the second directed acyclic graphs and identifying recurrent sequences of patterns in the first and second directed acyclic graphs based on the second order graph.

### STATEMENT OF GOVERNMENT INTEREST

This invention was made with United States Government support under Contract No. DE-NA0003525 between National Technology & Engineering Solutions of Sandia, LLC, and the United States Department of Energy. The United States Government has certain rights in this invention.

### BACKGROUND INFORMATION

### 1. Field

The present disclosure relates generally to data analysis and pattern recognition, and more specifically to a method and system for identifying recurrent causal sequences in temporal datasets.

### 2. Background

Acquisition of large, timestamped event datasets has become increasingly common across various domains. For example, in social media analytics, neuroscience research, and financial data analysis, large, timestamped event datasets are acquired. Identifying recurrent sequences of patterns within timestamped event data is important in data analysis and pattern recognition. Understanding causal patterns within temporal datasets is critical for decision-making, prediction, and inference.

The large datasets often comprise events that are temporally related, but more crucially, some events exert causal influence on others. Traditional methods of identifying recurrent sequences in temporal datasets primarily focus on temporal relationships, which may lead to overlooking significant causal patterns. Temporal relationships are insufficient for fully understanding the dynamics of complex systems generating these events.

### SUMMARY

An illustrative embodiment provides a computer-implemented method for identifying recurrent causal sequences in datasets. The method comprises receiving at least first and second datasets each comprising a plurality of data points. The method comprises computing a degree of causal relatedness for all pairs of the data points of the first and second datasets. The method comprises constructing a first directed acyclic graph on top of the first dataset by adding directed edges to pairs of data points whose degree of casual relatedness exceeds a threshold. The method comprises constructing a second directed acyclic graph on top of the second dataset by adding directed edges to data points whose degree of casual relatedness exceeds the threshold. The method comprises constructing a second order graph using the first and the second directed acyclic graphs. The method comprises identifying recurrent sequences of patterns in the first and second directed acyclic graphs based on the second order graph.

In an illustrative embodiment, the degree of causal relatedness between the pairs of the data points are computed using a relation function that quantifies the degree of causal relatedness between the data points.

In an illustrative embodiment, each vertex of the second order graph corresponds to one of the vertices of the first directed acyclic graph and one of the vertices of the second directed acyclic graph. Each edge of the second order graph corresponds to one of the edges of the first directed cyclic graph and one of the edges of the second directed cyclic graph.

In an illustrative embodiment, connected components of the second order graph correspond to recurrent causally similar sequence of events in the first and second directed acyclic graphs.

Another illustrative embodiment provides a system for identifying recurrent causal sequences in datasets. The system comprises a storage device configured to store program instructions. The system comprises one or more processors operably connected to the storage device and configured to execute the program instructions to cause the system to: receive at least first and second datasets each comprising a plurality of data points; compute a degree of causal relatedness for all pairs of the data points of the first and second datasets; construct a first directed acyclic graph on top of the first dataset by adding directed edges to pairs of data points whose degree of casual relatedness exceed a threshold; construct a second directed acyclic graph on top of the second dataset by adding directed edges to data points whose degree of casual relatedness exceed the threshold; construct a second order graph using the first and the second directed acyclic graphs; and identify recurrent sequences of patterns in the first and second directed acyclic graphs based on the second order graph.

Another illustrative embodiment provides a computer program product for identifying recurrent causal sequences in datasets. The computer program product comprises a computer-readable storage medium having program instructions embodied thereon to perform the steps of: receiving at least first and second datasets each comprising a plurality of data points; computing a degree of causal relatedness for all pairs of the data points of the first and second datasets; constructing a first directed acyclic graph on top of the first dataset by adding directed edges to pairs of data points whose degree of casual relatedness exceed a threshold; constructing a second directed acyclic graph on top of the second dataset by adding directed edges to data points whose degree of casual relatedness exceed the threshold; constructing a second order graph using the first and the second directed acyclic graphs; and identifying recurrent sequences of patterns in the first and second directed acyclic graphs based on the second order graph.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a network of data processing systems in which illustrative embodiments may be implemented;

FIG. 2 is a block diagram of a system for identifying recurrent causal sequences in temporal datasets in accordance with an illustrative embodiment;

FIG. 3 illustrates an example temporal dataset in accordance with an illustrative embodiment;

FIG. 4 illustrates an example causal relation graph in accordance with an illustrative embodiment;

FIGS. 5A and 5B illustrate example directed acyclic graphs in accordance with an illustrative embodiment;

FIG. 6 illustrates an example second order graph in accordance with an illustrative embodiment;

FIGS. 7 and 8 illustrate example datasets in accordance with an illustrative embodiment;

FIG. 9 depicts a flowchart of process for identifying recurrent causal sequences in temporal datasets in accordance with an illustrative embodiment; and

FIG. 10 illustrates a block diagram of a data processing system in accordance with an illustrative embodiment.

### DETAILED DESCRIPTION

The illustrative embodiments recognize and take into account one or more different considerations. The illustrative embodiments recognize and take into account that large datasets sometimes consist of timestamped events. During evolution of complex systems that generate these events, certain events exert causal influence on other events.

The illustrative embodiments recognize and take into account causal relations are distinct from temporal relations between events because patterns of events can recur with similar causal structure while having different temporal structure. This makes it difficult to identify recurrent causal sequences in these datasets.

The illustrative embodiments recognize and take into account that in large datasets consisting of timestamped events, often the causal patterns provide more information about the underlying system than the temporal patterns.

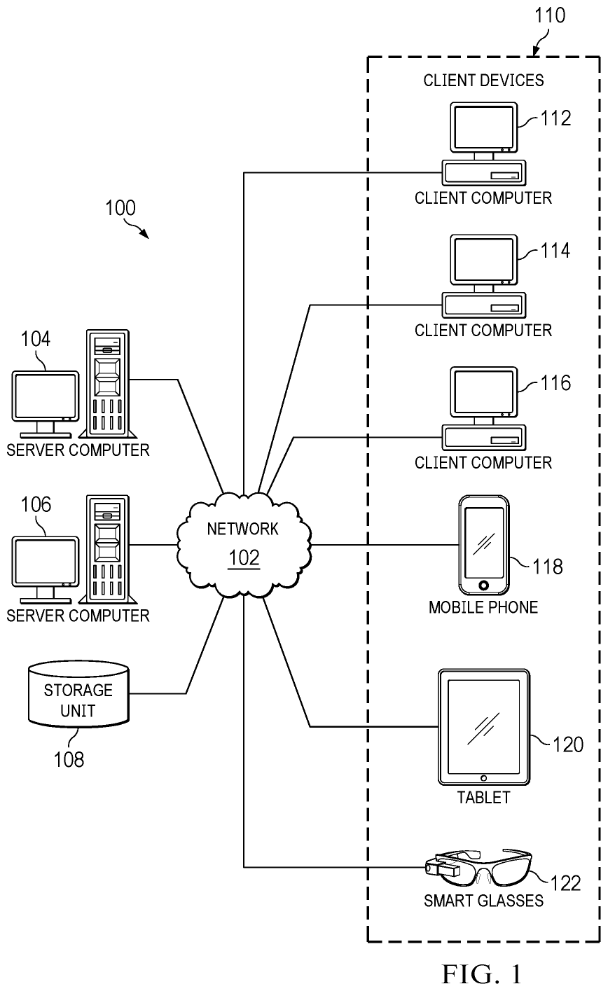

With reference to FIG. 1, a pictorial representation of a network of data processing systems is depicted in which illustrative embodiments may be implemented. Network data processing system 100 is a network of computers in which the illustrative embodiments may be implemented. Network data processing system 100 contains network 102, which is the medium used to provide communications links between various devices and computers connected within network data processing system 100. Network 102 may include connections, such as wire, wireless communication links, or fiber optic cables.

In the depicted example, server computer 104 and server computer 106 and storage unit 108 connect to network 102. In addition, client devices 110 connect to network 102. In the depicted example, server computer 104 provides information, such as boot files, operating system images, and applications to client devices 110. Client devices 110 can be, for example, computers, workstations, or network computers. As depicted, client devices 110 includes client computers 112, 114, and 116. Client devices 110 can also include other types of client devices such as mobile phone 118, tablet computer 120, and smart glasses 122.

In the illustrative example of FIG. 1, server computer 104 and server computer 106, storage unit 108, and client devices 110 are network devices that connect to network 102 in which network 102 is the communications media for these network devices. Some or all of client devices 110 may form an Internet of Things (IoT) in which these physical devices can connect to network 102 and exchange information with each other over network 102.

Program code located in network data processing system 100 can be stored on a computer-recordable storage medium and downloaded to a data processing system or other device for use. For example, the program code can be stored on a computer-recordable storage medium on server computer 104 and server computer 106 and storage unit 108 and downloaded to client devices 110 over network 102 for use on client devices 110.

In the illustrative example of FIG. 1, network 102 can be the Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using different types of networks. For example, network 102 can be comprised an intranet, a local area network (LAN), a metropolitan area network (MAN), or a wide area network (WAN). FIG. 1 is intended as an example, and not as an architectural limitation for the different illustrative embodiments.

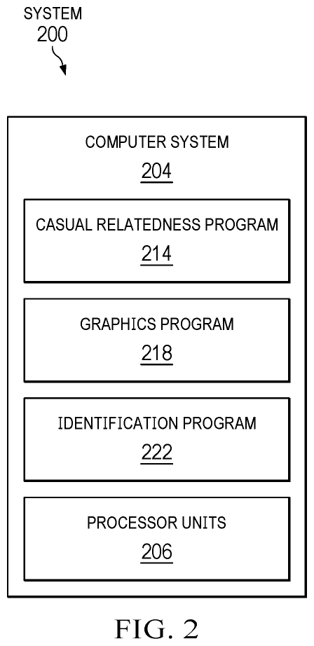

FIG. 2 is a block diagram of system 200 for identifying recurrent causal sequences in temporal datasets in accordance with an illustrative embodiment. System 200 comprises computer system 204 which is a physical hardware system and includes one or more data processing systems. When more than one data processing system is present in computer system 204, those data processing systems are in communication with each other using a communications medium. The data processing systems can be selected from at least one of a computer, a server computer, a tablet computer, or some other suitable data processing system.

In the illustrative example, the hardware system can take a form selected from at least one of discreet circuits, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As depicted, computer system 204 includes a number of processor units 206 that are capable of executing program codes implementing processes in the illustrative examples. As used herein, a processor unit in the number of processor units 206 is a hardware device and is comprised of hardware circuits such as those on an integrated circuit that respond and process instructions and program code that operate a computer. When a number of processor units 206 execute program codes for a process, the number of processor units 206 is one or more processor units that can be on the same computer or on different computers. In other words, the process can be distributed between processor units on the same or different computers in a computer system. Further, the number of processor units 206 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

Computer system 204 includes causal relatedness program 214 which includes program code for computing a degree of causal relatedness for all pairs of the data points of temporal data sets. Computer system 204 includes graphics program 218 which includes program code for constructing directed acyclic graphs on top of the temporal data sets. Graphics program 218 adds directed edges to pairs of data points whose degree of casual relatedness exceeds a threshold. Graphics program 218 also includes program code for constructing a second order graph based on two directed acyclic graphs.

Computer system 204 includes identification program 222 which includes program code for identifying recurrent sequences of patterns in the directed acyclic graphs based on the second order graph.

The illustration of system 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

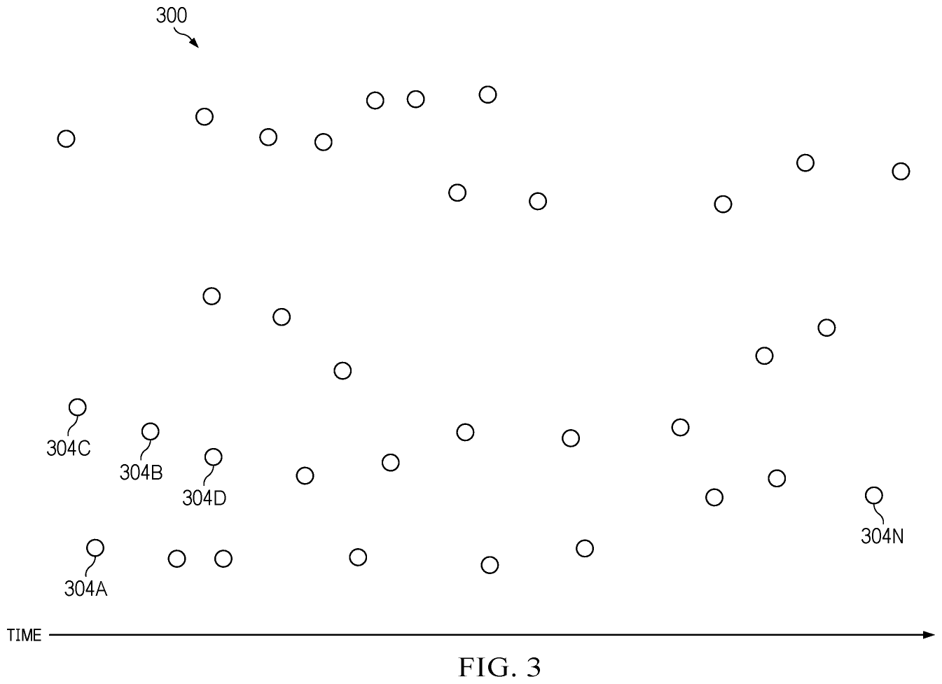

The illustrative embodiments provide a method and a system for identifying recurrent causal sequences in temporal data sets. FIG. 3 illustrates temporal dataset 300. Temporal dataset 300 includes data points or temporal events 304A-304N. Temporal events 304A-304N may, for example, include social media data, financial transaction data, or neural spike data. Temporal events 304A-304N can be recorded over a sequence of time intervals, wherein the sequence of time intervals represents a series of non-overlapping time periods.

In one illustrative embodiment, a directed acyclic graph is constructed on top of temporal events 304A-304N.

To form the directed acyclic graph, a relation function f(x, y) is applied on pairs of events. The relation function f(x, y) computes a degree of causal relatedness of two events. The relation function f(x) is application-specific. In one example embodiment, the relation function f(x, y) is a positive function that satisfies the condition f(x, y)≥0 for all values of x and y.

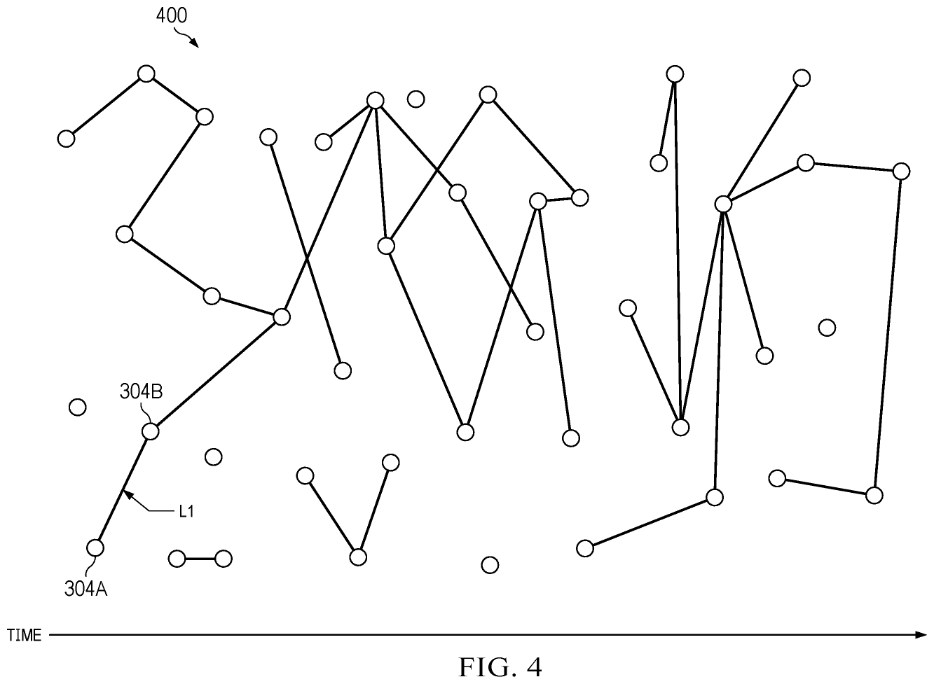

Based on causal relatedness, a causal relation graph is constructed. FIG. 4 illustrates an example causal relation graph 400 which is constructed from temporal dataset 300. In FIG. 4, pairs of events that are causally related but temporally separated are connected by lines. For example, line L1 connects events 304A and 304B because event 304A influenced event 304B. Thus, there is a causal relatedness between events 304A and 304B. Events that are not causally related to other events are not connected by lines.

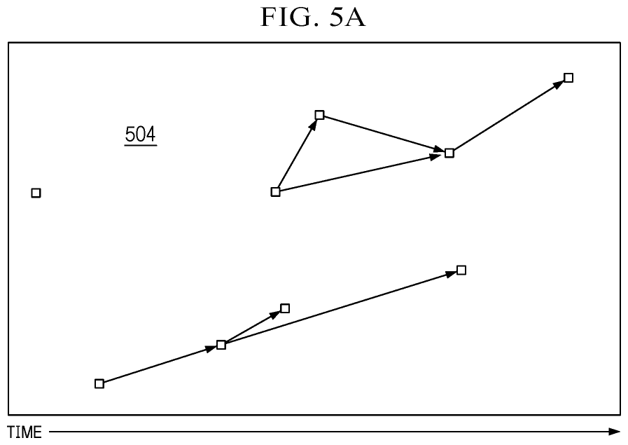

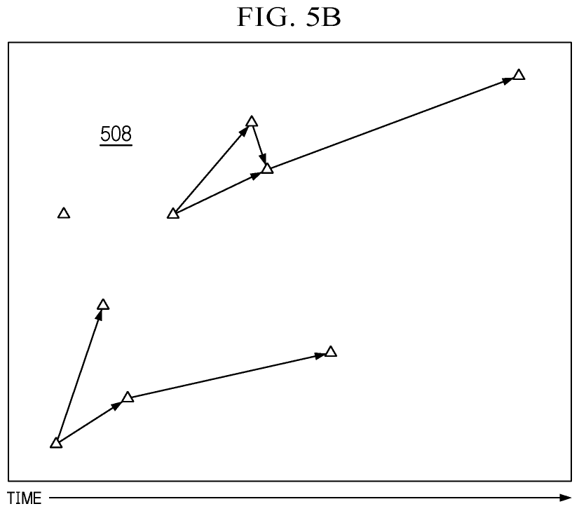

The function f(x, y) computes the degree of causal relatedness for pairs of events in the temporal dataset 300. For pairs of events that exceed a certain threshold, a directed edge is added to the graph. In one illustrative embodiment, the weight of the edge is the value of the function that specifies the degree of causal relatedness between the pair of events. This graph is called the directed acyclic graph. FIG. 5A illustrates directed acyclic graph 504, and FIG. 5B illustrates directed acyclic graph 508. Directed acyclic graph 504 and directed acyclic graph 508 are future directed and are constructed from respective datasets that are temporally separated.

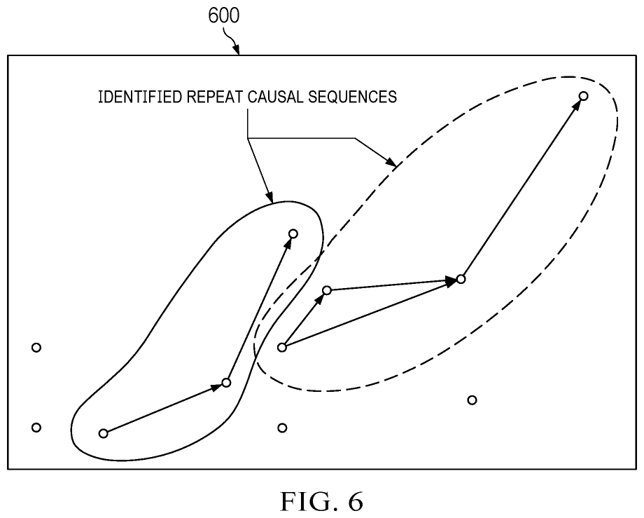

Based on directed acyclic graph 504 and directed acyclic graph 508, a second order graph is constructed. FIG. 6 illustrates second order graph 600 which is constructed using directed acyclic graph 504 and directed acyclic graph 508. Each vertex of second order graph 600 corresponds to a vertex of directed acyclic graph 504 and a vertex of directed acyclic graph 508. Thus, a pair of vertices in second order graph 600 contains four events in directed acyclic graph 504 and directed acyclic graph 508.

In one example embodiment, in second order graph 600, an edge is inserted from one vertex to another vertex if the ratio of the edge weights of x1→y1 and x2→y2 in the original directed acyclic causal relation graph are within a range centered around 1, where x1→y1 and x2→y2 defines two edges. This allows quantification of a degree of similarity between shared causal edges. For example, if the edge x1→y1 occurs with the same causal weight as the edge x2→y2, then the ratio of these weights is 1. In some example embodiments, if the ratio is not required to be 1, then the degree of causal similarity can be tuned to vary a shared causal interaction.

In one illustrative embodiment, a quadtree data structure (not shown) is used to construct a second order graph from two directed acyclic graphs. Other known techniques may be used to construct a second order graph from two directed acyclic graphs. The second order graph is then used to extract recurring casual sequences in the original datasets.

Referring back to FIG. 6, connected components of second order graph 600 correspond to recurrent causally-similar sequences of events in graphs in the original datasets. This correspondence is because edges in second order graph 600 correspond to a pair of edges in directed acyclic graph 504 and directed acyclic graph 508 that occur at different times. The edges of second order graph 600 are weakly connected to corresponding pair of edges in directed acyclic graph 504 and directed acyclic graph 508 because the edges of second order graph 600 occur at different times than edges of directed acyclic graph 504 and directed acyclic graph 508, but the edges of second order graph 600 preserve causal influence of corresponding edges of directed acyclic graph 504 and directed acyclic graph 508. The weakly connected components of second order graph 600 can be extracted using a known graph algorithm.

In one example embodiment, the second order graphs are used as training model objects. The training model objects can be applied to other datasets to identify recurring sequence of patterns.

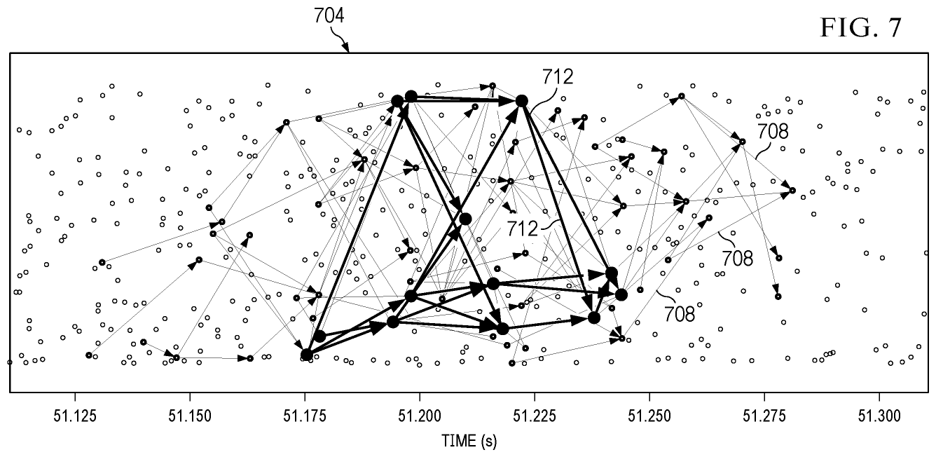

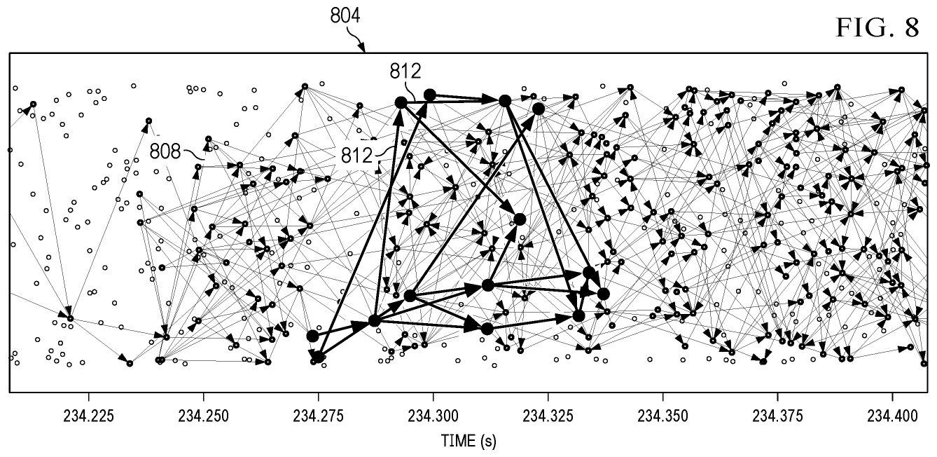

FIG. 7 illustrates first dataset 704 which includes many temporal events (i.e., data points) which are indicated by ticks. A relation function f(x, y) is used to construct directed acyclic graph 708 on top of the temporal events of first dataset 704. FIG. 8 illustrates second dataset 804 which includes many temporal events (i.e., data points) which are indicated by ticks. In some example embodiments, first dataset 704 and second dataset 804 may be subsets of a single dataset. Thus, first dataset 704 and second dataset 804 may be extracted from a single dataset.

The relation function f(x, y) was used to construct directed acyclic graph 808 on top of the temporal events. A second order graph (not shown) is then constructed using directed acyclic graph 708 and directed acyclic graph 808. The second order graph is then used to extract recurring causal sequence 712 and recurring causal sequence 812 in respective first dataset 704 and second dataset 804. Recurring causal sequence 712 and recurring causal sequence 812 are indicated by bold directed arrows in FIGS. 7 and 8. Recurring causal sequences reappear embedded in first dataset 704 and second dataset 804. In the recurring causal sequences, precise timing of the events of first dataset 704 and second dataset 804 is not preserved but causal influence is preserved.

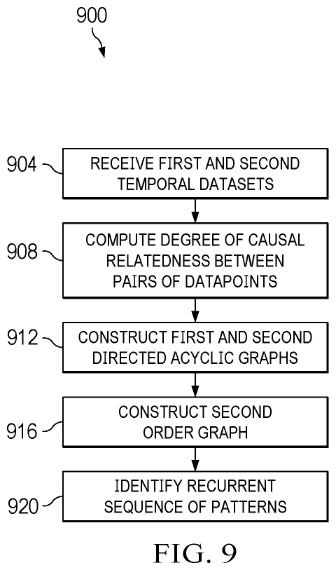

FIG. 9 depicts a flowchart of process 900 for identifying recurrent causal sequences in temporal datasets. First and second temporal data sets are received (step 904). Each dataset comprises a plurality of data points which are also referred to as events. The plurality of data points or events are recorded over a sequence of time intervals which represent a series of non-overlapping time periods.

A degree of causal relatedness for all pairs of the data points of the first and second temporal data sets are computed (step 908). In one illustrative embodiment, a relation function f(x, y) is used to compute the degree of causal relatedness between the pairs of the data points. In one example embodiment, the relation function f(x, y) is a positive function that satisfies the condition f(x, y)≥0 for all values of x and y.

A first directed acyclic graph is constructed on top of the first temporal data set by adding directed edges to pairs of data points whose degree of casual relatedness exceed a threshold, and a second directed acyclic graph is constructed on top of the second data set by adding directed edges to data points whose degree of casual relatedness exceed the threshold (step 912). A second order graph is constructed using the first and the second directed acyclic graphs (step 916). The connected components of the second order graph correspond to recurrent causally similar sequence of events in the first and second directed acyclic graphs.

Based on the second order graph, recurrent sequences of patterns in the first and second directed acyclic graphs are identified (step 920). The recurring causal sequences reappear embedded in original datasets. In the recurring causal sequences, precise timing is not preserved but causal influence of the original datasets is preserved.

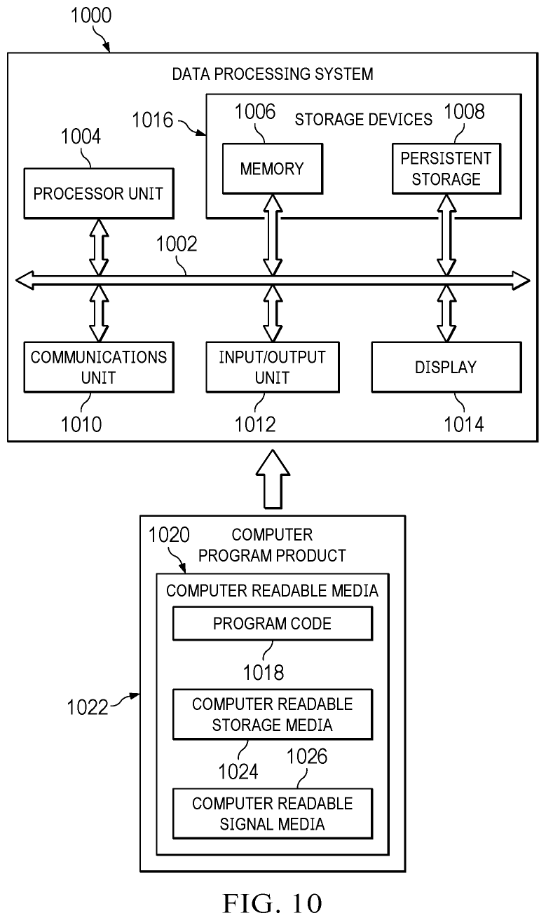

Turning now to FIG. 10, an illustration of a block diagram of a data processing system is depicted in accordance with an illustrative embodiment. Data processing system 1000 may be used to implement server computer 104 and server computer 106 and client devices 110 in FIG. 1, as well as system 200 in FIG. 2. In this illustrative example, data processing system 1000 includes communications framework 1002, which provides communications between processor unit 1004, memory 1006, persistent storage 1008, communications unit 1010, input/output unit 1012, and display 1014. In this example, communications framework 1002 may take the form of a bus system.

Processor unit 1004 serves to execute instructions for software that may be loaded into memory 1006. Processor unit 1004 may be a number of processors, a multi-processor core, or some other type of processor, depending on the particular implementation. In an embodiment, processor unit 1004 comprises one or more conventional general-purpose central processing units (CPUs). In an alternate embodiment, processor unit 1004 comprises one or more graphical processing units (GPUs).

Memory 1006 and persistent storage 1008 are examples of storage devices 1016. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1016 may also be referred to as computer-readable storage devices in these illustrative examples. Memory 1006, in these examples, may be, for example, a random access memory or any other suitable volatile or non-volatile storage device. Persistent storage 1008 may take various forms, depending on the particular implementation.

For example, persistent storage 1008 may contain one or more components or devices. For example, persistent storage 1008 may be a hard drive, a flash memory, a rewritable optical disk, a rewritable magnetic tape, or some combination of the above. The media used by persistent storage 1008 also may be removable. For example, a removable hard drive may be used for persistent storage 1008. Communications unit 1010, in these illustrative examples, provides for communications with other data processing systems or devices. In these illustrative examples, communications unit 1010 is a network interface card.

Input/output unit 1012 allows for input and output of data with other devices that may be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs may be located in storage devices 1016, which are in communication with processor unit 1004 through communications framework 1002. The processes of the different embodiments may be performed by processor unit 1004 using computer-implemented instructions, which may be located in a memory, such as memory 1006.

These instructions are referred to as program code, computer-usable program code, or computer-readable program code that may be read and executed by a processor in processor unit 1004. The program code in the different embodiments may be embodied on different physical or computer-readable storage media, such as memory 1006 or persistent storage 1008.

Program code 1018 is located in a functional form on computer-readable media 1020 that is selectively removable and may be loaded onto or transferred to data processing system 1000 for execution by processor unit 1004. Program code 1018 and computer-readable media 1020 form computer program product 1022 in these illustrative examples. In one example, computer-readable media 1020 may be computer-readable storage media 1024 or computer-readable signal media 1026.

In these illustrative examples, computer-readable storage media 1024 is a physical or tangible storage device used to store program code 1018 rather than a medium that propagates or transmits program code 1018. Computer readable storage media 1024, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1018 may be transferred to data processing system 1000 using computer-readable signal media 1026. Computer-readable signal media 1026 may be, for example, a propagated data signal containing program code 1018. For example, computer-readable signal media 1026 may be at least one of an electromagnetic signal, an optical signal, or any other suitable type of signal. These signals may be transmitted over at least one of communications links, such as wireless communications links, optical fiber cable, coaxial cable, a wire, or any other suitable type of communications link.

The different components illustrated for data processing system 1000 are not meant to provide architectural limitations to the manner in which different embodiments may be implemented. The different illustrative embodiments may be implemented in a data processing system including components in addition to or in place of those illustrated for data processing system 1000. Other components shown in FIG. 10 can be varied from the illustrative examples shown. The different embodiments may be implemented using any hardware device or system capable of running program code 1018.

As used herein, “a number of,” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware may, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams may be implemented using special purpose hardware systems that perform the different operations or combinations of special purpose hardware and program code run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

The different illustrative examples describe components that perform actions or operations. In an illustrative embodiment, a component may be configured to perform the action or operation described. For example, the component may have a configuration or design for a structure that provides the component with an ability to perform the action or operation that is described in the illustrative examples as being performed by the component.

Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

1. A computer-implemented method for identifying recurrent causal sequences in datasets, comprising:
receiving at least first and second datasets each comprising a plurality of data points;
computing a degree of causal relatedness for all pairs of the data points of the first and second datasets;
constructing a first directed acyclic graph on top of the first dataset by adding directed edges to pairs of data points whose degree of casual relatedness exceed a threshold;
constructing a second directed acyclic graph on top of the second dataset by adding directed edges to data points whose degree of casual relatedness exceed the threshold;
constructing a second order graph using the first and the second directed acyclic graphs; and
identifying recurrent sequences of patterns in the first and second directed acyclic graphs based on the second order graph.

2. The method of claim 1, wherein the degree of causal relatedness between the pairs of the data points are computed using a relation function that quantifies the degree of causal relatedness between the data points.

3. The method of claim 1, wherein each vertex of the second order graph corresponds to one of the vertices of the first directed acyclic graph and one of the vertices of the second directed acyclic graph.

4. The method of claim 1, wherein each edge of the second order graph corresponds to one of the edges of the first directed cyclic graph and one of the edges of the second directed cyclic graph.

5. The method of claim 1, wherein connected components of the second order graph correspond to recurrent causally similar sequence of events in the first and second directed acyclic graphs.

6. The method of claim 1, further comprising:
comparing the second order graph to the first and second directed acyclic graphs; and
identifying recurrent sequences of patterns in the first and the second directed acyclic graphs based on the comparison.

7. The method of claim 1, wherein the plurality of data points are recorded over a sequence of time intervals.

8. The method of claim 7, wherein the sequence of time intervals represents a series of non-overlapping time periods.

9. The method of claim 1, wherein the first and second datasets are first and second subsets of a single dataset.

10. A system for identifying recurrent causal sequences in datasets, the system comprising:
a storage device configured to store program instructions; and
one or more processors operably connected to the storage device and configured to execute the program instructions to cause the system to:
receive at least first and second datasets each comprising a plurality of data points;
compute a degree of causal relatedness for all pairs of the data points of the first and second datasets;
construct a first directed acyclic graph on top of the first dataset by adding directed edges to pairs of data points whose degree of casual relatedness exceed a threshold;
construct a second directed acyclic graph on top of the second dataset by adding directed edges to data points whose degree of casual relatedness exceed the threshold;
construct a second order graph using the first and the second directed acyclic graphs; and
identify recurrent sequences of patterns in the first and second directed acyclic graphs based on the second order graph.

11. The system of claim 10, wherein the degree of causal relatedness between the pairs of the data points are computed using a relation function that quantifies the degree of causal relatedness between the data points.

12. The system of claim 10, wherein each vertex of the second order graph corresponds to one of the vertices of the first directed acyclic graph and one of the vertices of the second directed acyclic graph.

13. The system of claim 10, wherein each edge of the second order graph corresponds to one of the edges of the first directed cyclic graph and one of the edges of the second directed cyclic graph.

14. The system of claim 10, wherein connected components of the second order graph correspond to recurrent causally similar sequence of events in the first and second directed acyclic graphs.

15. The system of claim 10, wherein the first and second datasets are first and second subsets of a single dataset.

16. A computer program product for identifying recurrent causal sequences in datasets, the computer program product comprising:
a computer-readable storage medium having program instructions embodied thereon to perform the steps of:
receiving at least first and second datasets each comprising a plurality of data points;
computing a degree of causal relatedness for all pairs of the data points of the first and second datasets;
constructing a first directed acyclic graph on top of the first dataset by adding directed edges to pairs of data points whose degree of casual relatedness exceed a threshold;
constructing a second directed acyclic graph on top of the second dataset by adding directed edges to data points whose degree of casual relatedness exceed the threshold;
constructing a second order graph using the first and the second directed acyclic graphs; and
identifying recurrent sequences of patterns in the first and second directed acyclic graphs based on the second order graph.

17. The computer program product of claim 16, wherein the degree of causal relatedness between the pairs of the data points are computed using a function that quantifies the degree of causal relatedness between the data points.

18. The computer program product of claim 16, wherein each vertex of the second order graph corresponds to one of the vertices of the first directed acyclic graph and one of the vertices of the second directed acyclic graph.

19. The computer program product of claim 16, wherein each edge of the second order graph corresponds to one of the edges of the first directed cyclic graph and one of the edges of the second directed cyclic graph.

20. The computer program product of claim 16, wherein connected components of the second order graph correspond to recurrent causally similar sequence of events in the first and second directed acyclic graphs.
